(19) United States
(12) Patent Application Publication
(10) Pub. No.: US 2003/0188555 A1
(43) Pub. Date: Oct. 9, 2003

(54) Fused bi-conical coupler pulling technique

(76) Inventors: Michael Richard Henning, Crozet, VA (US); Michael Lockhart, Charlottesville, VA (US); Roger Lynn Reynolds, Charlottesville, VA (US); Susan Lynn Ritenour Barker, Charlottesville, VA (US); Kristen Wilson Sellers, Crozet, VA (US)

Correspondence Address: Gifford, Krass, Groh, Suite 400, 280 N. Old Woodward Ave., Birmingham, MI, 48009, US

(21) Appl. No.: 10/117,655

(22) Filed: Apr. 5, 2002

(51) Int. Cl. C03B 37/025; C03B 37/07

(52) U.S. Cl. 65/381; 65/435; 65/486

(57) ABSTRACT

Apparatus and methods allow fused bi-conical couplers to be pulled to reduced diameters to exposes more of the evanescent field in the coupled region. First and second stages hold the fibers on either side of the fused region, with at least one of the stages being moveable relative to the other. A furnace positioned relative to the fused region, and a tensometer is used to determine the tension of the fibers between the stages. A controller is provided to monitor the tension on the fibers and increase the distance between the stages when the tension falls to a predetermined threshold. As the fibers are pulled, light begins to couple from one fiber to the next, leading to five distinct crossover regions. The tension is continuously monitored, and when the tension drops below each threshold, the furnace is slowly pushed back to maintain the tension by decreasing the heat on the fiber from the furnace. As the fiber is pulled through these crossover areas, the coupling region decreases in diameter. Additionally, the “z” region, or coupling area, is also lengthened as the fiber is pulled through multiple crossovers.

### FIELD OF THE INVENTION

This invention relates generally to fiber-optic couplers and, in particular, to methods and apparatus for pulling reduced-diameter couplers.

### BACKGROUND OF THE INVENTION

Fiber-optic couplers are useful in many applications. In the field of optical communications, for example, such devices may be used as wavelength-division multiplexers, enabling optical radiation at two or more wavelengths to be combined at a desired ratio. Couplers are also useful in chemical/biological sensing, wherein molecular bonding within an evanescent field generated at the fused region induces changes in optical transmission which are detectable.

Fused bi-conical tapered couplers are conventionally formed by placing two bare single-mode fibers in contact with each other, adding tension to the fibers, and heating the fibers using a heat source. As the fibers soften, they fuse together and form the fused biconical tapered coupler. In some applications such as chemical/biological sensing, it is important that the fused region be as narrow as possible to enhance evanescent field generation and device sensitivity. As such, considerable efforts have been made to control the optical performance of the fused bi-conical tapered coupler during manufacture.

U.S. Pat. No. 4,763,272 to McLandrich describes a fiber coupler fabrication system using computer-controlled, motor-driven fiber-elongation translation stages. After at least two optical fibers are juxtaposed and heated, the stages are toggled at an exact rate relative to the fibers in order to control the temperatures of the fibers. The computer is interfaced to optical power monitoring detectors at the outputs of the individual fibers, enabling the coupling characteristics of the fibers to be specifically adjusted by monitoring the power outputs of the optical fibers and controlling the timed removal of the heat source and termination of the translation stages to achieve the desired results.

U.S. Pat. No. 4,765,816 to Bjornlie et al. describes a method and apparatus for making fiber optic couplers including the steps of stretching a fused optical fiber pair at a predetermined rate to first produce a tapered section, then a constant-diameter cylindrical section, followed by a final, tapered section. The two optical fibers are placed in juxtaposition under a predetermined load, heated to a predetermined temperature until they fuse together to form a single entity having a predetermined width, length and circular cross section. Two moveable platforms apply a predetermined tensile load to the fibers and move the fibers past a heat source in a controlled manner to form the different sections.

U.S. Pat. No. 5,871,559 to Bloom is directed to a machine for automated fabrication of a fiber optic device. An interface enclosing a fabrication environment includes a stationary gripping device securing an end of a first optical fiber. The machine also includes first and second movable stages within the environment, each including a clamp for securing an exposed portion of the first optical fiber. A heat source is used to apply heat to the first optical fiber at a selected intensity, and a plurality of movable gripping devices within the environment are configured to successively transport the end of the first optical fiber from the stationary gripping device to a prescribed position. The machine also includes a controller for controlling the movement of the first optical fiber by the movable gripping devices, and for controlling the movement of the first and second stages and the position and intensity of the heat source to form the fiber-optic device.

U.S. Pat. Nos. 6,112,555; 6,018,965; 5,948,134; and 5,931,983 to Bloom reside in fused biconical tapered couplers formed from the pulling of heated optical fibers. The coupling ratios are controlled by dynamically adjusting the heat intensity and pull speed during fabrication. Fabrication begins by arranging two optical fibers, heating the optical fibers using a heat source a predetermined distance from the optical fibers, and pulling the optical fibers at an initial pulling velocity as the heated optical fibers soften. The heat source is moved away from the optical fibers, and the pulling velocity is selectively reduced in response to a substantial change in the detected coupling ratio. Changes in the coupling ratio are controlled by selectively reducing the pulling speed and the heat intensity to a point where the pulling of the optical fibers may be halted, and the heat removed, without a substantial change in the detected coupling ratio. The coupling ratio may be monitored at different wavelengths for fabrication of wideband couplers and wavelength division multiplexers. Although prior-art apparatus and methods are capable of producing fused couplers suitable for certain telecom applications, existing techniques are incapable of routinely producing couplers with less than 30 micron diameter. More demanding applications, however, require much smaller diameter couplers, however, in some cases with dimensions of 10-15 microns or less. Improved equipment is required to meet these design challenges.

### SUMMARY OF THE INVENTION

This invention improves upon the prior art by allowing fused bi-conical couplers to be pulled to reduced diameters of 10-15 microns and below. In a sensor application, this exposes more of the evanescent field in the coupled region and produces a greater effect on changes of index of refraction in the region of effective cladding.

In terms of apparatus, the invention includes first and second stages operative to hold the fibers on either side of the fused region, with at least one of the stages being moveable relative to the other. A furnace positioned relative to the fused region, and a tensometer is used to determine the tension of the fibers between the stages. A controller is provided to monitor the tension on the fibers and increase the distance between the stages when the tension falls to a predetermined threshold.

In the preferred embodiment, only one of the stages is movable, but the furnace is moveable as well, and the controller is operative to move the furnace along the fibers so that it remains positioned relative to the fused region. In an alternative embodiment, both stages move apart on a controlled basis enabling the furnace to remain stationary at least along the length of the fibers.

In the preferred embodiment, the furnace is also moveable at least away from the fused region, and the controller is further operative to maintain a consistent tension on the fibers by the moving the furnace away from the fused region as the distance between the stages is increased. A method of pulling a fiber optical coupler to achieve a reduced diameter fused region according to the invention includes the steps of heating the fused region; monitoring the tension on the fibers; and pulling the fibers when the tension on the fibers reaches a predetermined threshold.

As the fibers are pulled, light couples from one fiber to the next, leading to multiple areas where the light output between the fibers is the same, a crossover point. The tension is continuously monitored, and when the tension drops below each threshold, the furnace is slowly pushed back to maintain the tension by decreasing the heat on the fiber from the furnace. As the fiber is pulled through these crossover areas, the coupling region decreases in diameter. Additionally, the “z” region, or coupling area, is also lengthened as the fiber is pulled through multiple crossovers.

### BRIEF DESCRIPTION OF THE DRAWINGS

FIG. 1 is a drawing which illustrates an automated coupler pulling station according to the invention;

FIG. 2 illustrates a fiber threaded through a tensometer;

FIG. 3 shows a fiber proceeding through a furnace to another movable stage; FIG. 4 shows how the fiber remains in the same relative position inside the furnace;

FIG. 5 illustrates a graph of a coupler being stretched to a point of equilibrium before breaking;

FIG. 6 shows a graph of a coupler being pulled with a stationary furnace; and

FIG. 7 is a diagram that depicts what happens to light output as the coupler is stretched according to Bures.

### DETAILED DESCRIPTION OF THE INVENTION

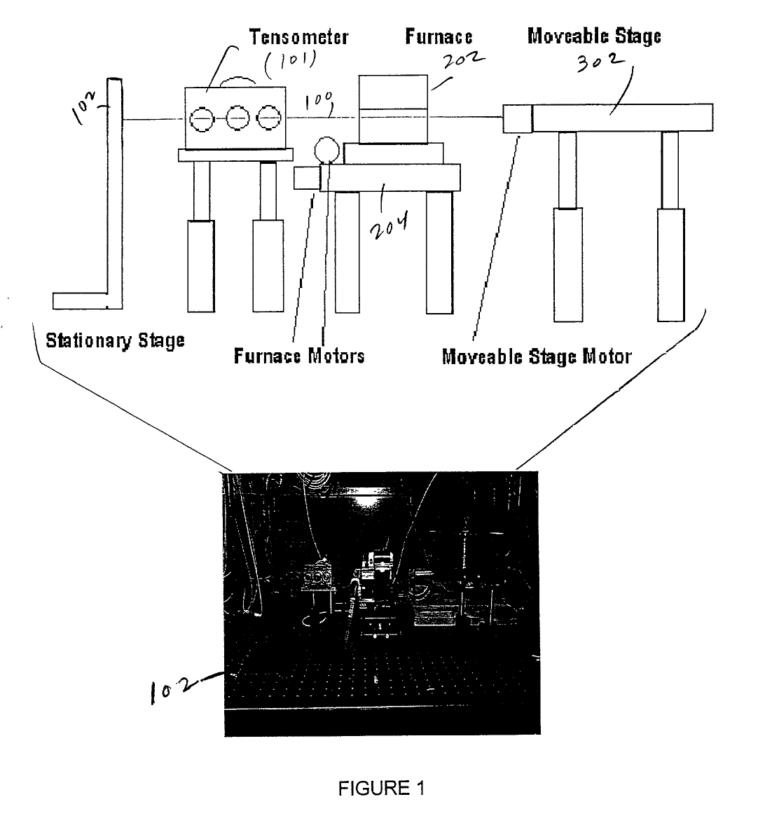

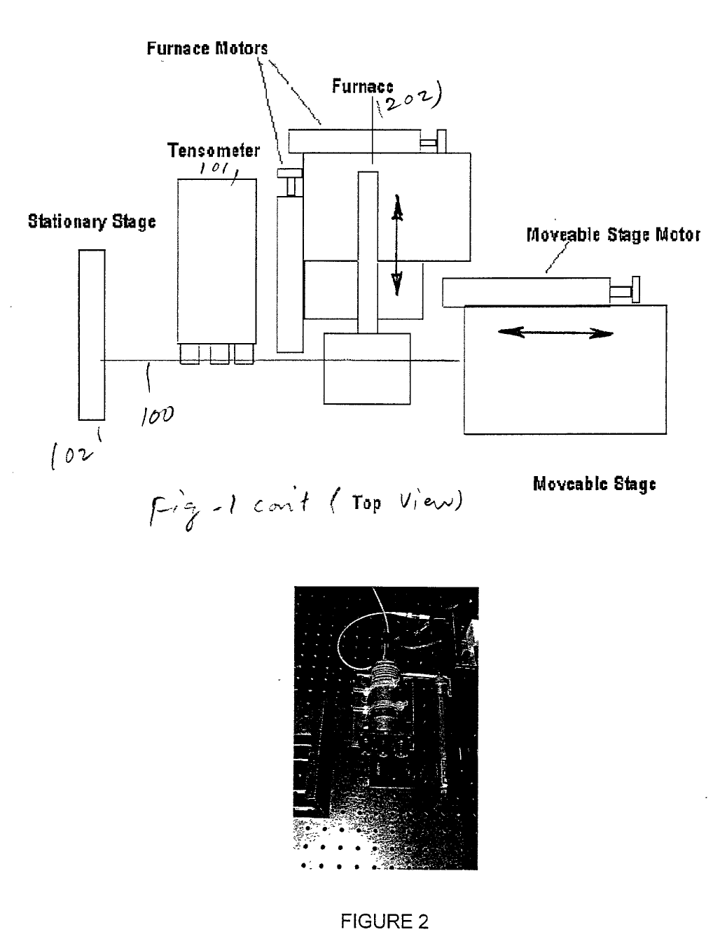

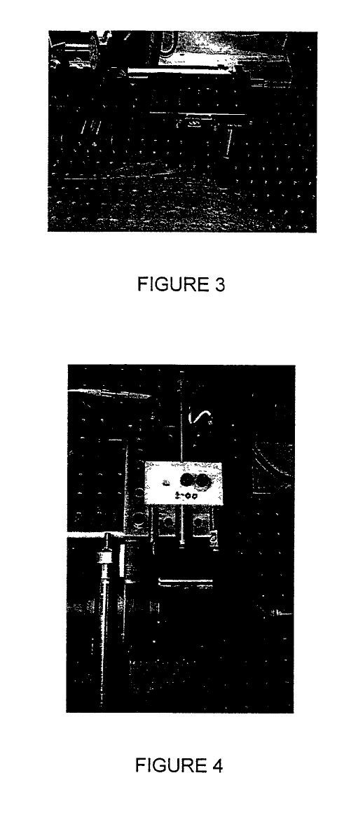

Reference is now made to the Figures, wherein like numerals are used to depict common subject matter throughout. FIG. 1 is an overview of an automated coupler pulling station according to the invention. A stationary stage 102 is shown on the left The fibers 100 feeds through a tensometer, best seen in FIG. 2, and then through furnace 202, which is on a moveable stage 204. The fibers then proceed through the furnace to another moveable stage 302 on the right-hand side, best seen in FIG. 3.

In operation, the fibers are pulled and the tension is monitored using the tensometer. As the tension on the tensometer eases, the motors are activated. The furnace, shown in FIG. 4, is moved half of the distance that the movable stage moves, thereby keeping the fibers in the same relative position inside the furnace. Although, in the preferred embodiment, the furnace and a single stage is moveable, in an alternative embodiment a stationary furnace may be used in conjunction with two moveable stations on either end of the furnace moving in opposite directions.

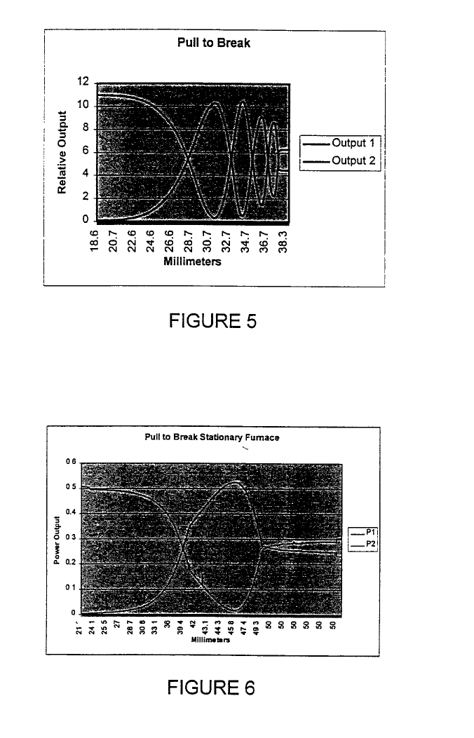

As the fibers are pulled light couples from one fiber to the next leading to areas where the light output between the fibers is equal, a crossover point. FIG. 5 shows a coupler with five such crossovers. The tension is continuously monitored, and when the tension drops below each threshold, the furnace is slowly pushed back to maintain the tension by decreasing the heat on the fiber from the furnace. As the fiber is pulled through these crossover areas, the coupling region decreases in diameter. Additionally, the “z” region, or coupling area, is also lengthened as the fiber is pulled through multiple crossovers.

FIG. 6 shows the graph of a coupler being pulled with a stationary furnace. As seen, two crossovers are realized and the fiber is stretched a greater distance with the moveable furnace, but the resulting coupling area is actually smaller since there is little fusion in the increased pull length and the fibers are easily separated after pulling.

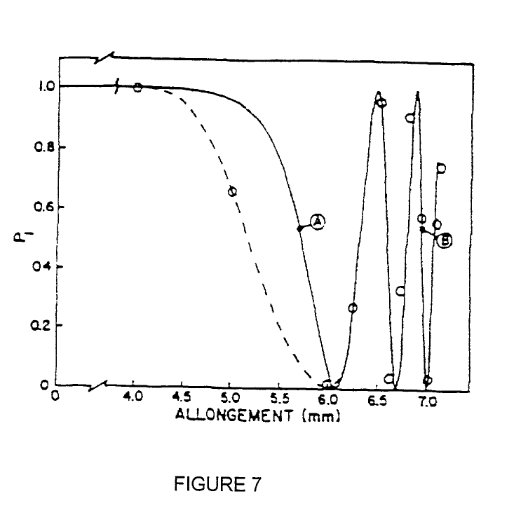

Pulling fibers to produce couplers using this method allows the diameter of the coupling region to be reduced which, in turn, affects the coefficient of coupling as described by Bures et al. FIG. 7 is a graph according to Bures that shows what happens to light output as a coupler is stretched to breaking. The graph of FIG. 5 shows that as the coupler is stretched to breaking in accordance with this invention it reaches a point of equilibrium before breaking, which contradicts the theoretical diagram FIG. 7.

We claim:

1. Apparatus for pulling a fiber optical coupler to achieve a reduced diameter fused region, comprising:
first and second stages operative to hold the fibers on either side of the fused region, with at least one of the stages being moveable relative to the other;
a furnace positioned relative to the fused region;
a tensometer to determine the tension of the fibers between the stages; and
a controller operative to monitor the tension on the fibers and increase the distance between the stages when the tension falls to a predetermined threshold.

2. The apparatus of claim 1, wherein both stages move apart on a controlled basis enabling the furnace to remain stationary at least along the length of the fibers.

3. The apparatus of claim 1, wherein:
only one of the stages is moveable, but the furnace is also moveable; and
the controller is further operative to move the furnace along the fibers so that it remains positioned relative to the fused region.

4. The apparatus of claim 1, wherein:
the furnace is moveable a t least away from the fused region; and
the controller is further operative to maintain a consistent tension on the fibers by the moving the furnace away from the fused region as the distance between the stages is increased.

5. Apparatus for pulling a fiber optical coupler to achieve a reduced diameter fused region, comprising:
first and second stages operative to hold the fibers on either side of the fused region, with at least one of the stages being moveable relative to the other;
a furnace which is moveable at least away from the fused region;
a tensometer to determine the tension of the fibers between the stages; and
a controller operative to perform the following functions:
a) monitor the tension on the fibers and increase the distance between the stages when the tension falls to a predetermined threshold; and
b) move the furnace away from the fused region as the distance between the stages is increased to maintain a consistent tension on the fibers.

6. The apparatus of claim 5, wherein both stages move apart on a controlled basis enabling the furnace to remain stationary at least along the length of the fibers.

7. The apparatus of claim 5, wherein:
only one of the stages is moveable, but the furnace is also moveable; and
the controller is further operative to move the furnace along the fibers so that it remains positioned relative to the fused region.

8. A method of pulling a fiber optical coupler to achieve a reduced diameter fused region, comprising the steps of:
heating the fused region;
monitoring the tension on the fibers; and
pulling the fibers when the tension on the fibers reaches a predetermined threshold.

9. The method of claim 8, wherein both stages are moved apart on a controlled basis while keeping the furnace remains stationary.

10. The method of claim 8, wherein one of the stages and the furnace is moved such that the furnace remains positioned relative to the fused region.

11. The method of claim 8, wherein the furnace is moved away from the fused region as the distance between the stages is increased so as to maintain a consistent tension on the fibers.

12. A method of pulling a fiber optical coupler to achieve a reduced diameter fused region, comprising the steps of:
providing first and second stages operative to hold the fibers on either side of the fused region, with at least one of the stages being moveable relative to the other;
providing a furnace which is moveable at least away from the fused region;
monitoring the tension on the fibers and increasing the distance between the stages when the tension falls to a predetermined threshold; and
moving the furnace away from the fused region as the distance between the stages is increased to maintain a consistent tension on the fibers.

13. The method of claim 12, including the step of moving both stages apart on a controlled basis while keeping the furnace stationary.

14. The method of claim 12, including the step of moving one of the stages and the furnace so that the furnace remains positioned relative to the fused region.
